(19) United States
(12) Patent Application Publication
(10) Pub. No.: US 2006/0048188 A1
(43) Pub. Date: Mar. 2, 2006

(54) Methods and systems for logging a user off of a set-top box

(76) Inventor: Thomas Poslinski, Elma, NY (US)

Correspondence Address: Steven L. Nichols;Rader, Fishman, & Grauer PLLC, River Park Corporate Center One, River Front Pkwy., Ste. 150, South Jordan, UT, 84095, US

(21) Appl. No.: 10/925,476

(22) Filed: Aug. 25, 2004

(51) Int. Cl. H04N 7/025; H04N 7/173; H04N 5/445; H04N 7/10; H04N 7/16; G06F 3/00

(52) U.S. Cl. 725/46; 725/34; 725/35; 725/100; 725/131; 725/151

(57) ABSTRACT

A set-top box includes a processor and a receiver for communicating with a remote control unit. The processor is configured to receive a command from the remote control unit to automatically log a user off of the set-top box. The user is automatically logged off in response to receipt of the command from the remote control unit.

### TECHNICAL FIELD

The present specification relates broadly to the fields of video equipment and home entertainment systems including, for example, components such as television sets, video recorders and set-top boxes.

### BACKGROUND

In most video or home entertainment systems, a television or video monitor is used to watch broadcast and recorded television programming. The broadcast signal carrying the programming shown on the television set may come from, for example, a terrestrial antenna, a cable television system or a satellite dish. Modern users may have access to hundreds of channels of programming as well as pay-per-view service, video-on-demand service and other services.

In most such system, additional electronics are needed to allow the television set to access and display the variety of available programming. These additional electronics are typically incorporated into a terminal, known as a set-top box. The set-top box is connected to the television set and provides a programming signal for the television set to display. The set-top box is also connected to a signal source, for example, a cable television system or satellite dish, and processes a programming signal from that signal source into a form that can be used and displayed by the television set.

In addition to providing access to the programming from a cable or satellite service provider, a set-top box may also perform other functions for the user. For example, the set-top box may incorporate a video recorder that can record video programming for later playback as desired by a user. Such video recorders are known as Personal Video Recorders (PVRs) or Digital Video Recorders (DVRs).

### SUMMARY

A set-top box includes a processor and a receiver for communicating with a remote control unit. The processor is configured to receive a command from the remote control unit to automatically log a user off of the set-top box. The user is automatically logged off in response to receipt of the command from the remote control unit.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a diagram showing a set-top box and television set according to the principles described herein.

FIG. 2 is a flowchart showing a method of operating the set-top box and television set of FIG. 1.

FIG. 3 is a diagram showing another set-top box and television set according to the principles described herein.

FIG. 4 is a flowchart showing a method of operating the set-top box and television set of FIG. 3.

Throughout the drawings, identical reference numbers designate similar, but not necessarily identical, elements.

### DETAILED DESCRIPTION

As noted above, a set-top box can enable access to the various channels of television programming and other services offered by a service provider. The set-top box can also include a video recorder that can record and playback video programming as desired by a user.

As used herein and in the following claims, the term “set-top box” will be broadly defined to mean electronics, in a separate terminal or incorporated into a television set, that provide a programming signal from a service provider for display on a television set and/or record video programming for later playback as desired by a user. Thus, as defined herein, a set-top box may be, or include, a PVR or DVR.

The term “service provider” will be understood to mean any party providing services to a set-top box including, but not limited to, a terrestrial television broadcasting company, a cable television company or a satellite television company.

While such service providers may make hundreds of channels of programming and other services available to users, it will be understood, however, that not all such programming, whether recorded or broadcast, will be appropriate for all members of a household or for all users of a particular television and set-top box. For example, if there are children that use the television and set-top box, there may be programming available from the service provider or recorded on the set-top box that is not appropriate for viewing by children.

Additionally, the users of the television and set-top box will almost certainly have different interests and be interested in viewing and/or recording different programming. Consequently, a particular user may not want to have to look through the programming recorded by other users of the same system in order to find a program that user desired to replay.

To address these situations, a set-top box may be programmed to operate differently for different users. A user profile is created and stored on the set-top box for each individual user who wants to use the set-top box. For example, if an adult logs into a set-top box by providing a password or other identifier, the set-top box will access the user profile for that user and may allow the adult to tune or access any channel or programming available from the service provider. However, if a child logs into the set-top box by providing a password or other identifier, the set-top box will access the user profile for the child user and may be programmed to refuse to tune or access certain channels or types of programming available from the service provider. A user profile and corresponding specific restrictions can be set for any number of users of a set-top box.

Similarly, each user of the set-top box may record programming of interest to that user. The recording will then be associated with the login and profile of the user who recorded it and may be accessible only to that user. Any other user logging into the set-top box may have access only to programming that he or she has recorded. Although some user profiles may be created that give certain other users access to the programming that another user has recorded.

In this way, parents have some control over what programming, broadcast or recorded, is accessed and viewed by the children in the household. Additionally, each user has some privacy as to the programming he or she has chosen to record for subsequent playback. And, a particular user need only look through the programming he or she has recorded when looking for a particular program to playback.

One of the users of the set-top box may be designated as the master user with the rights to create or modify all other user profiles. The master user may also have access to programming recorded by other users or may grant rights for one user to access the programming recorded by another user.

As used herein and in the appended claims, a user “logs in” to a set-top box by providing a password or other identifier such that the set-top box is able to identify and activate the user profile for that user. The user then has access to channels and services as dictated by his or her user profile. The logged in user also has access to programming that he or she has recorded on the set-top box.

A user “logs off” or “logs out” of a set-top terminal by deactivating his or her user profile. This will generally deactivate access to programming that user has recorded and to the channels and services that user is allowed to access in favor of more restrictive access for a “guest user” profile that will be described in more detail below.

However, when a typical user is done watching television, it is usually the case that the user turns off the television, but leaves the set-top box on. If a user is logged into the set-top box and then turns off the television, leaving the set-top box on and logged in, the next person to come along and turn on the television will have access to the set-top box account of the previous user. If the previous user had been watching a broadcast channel, that channel will likely still be playing when the television is turned back on. If the previous user had been watching a playback of a recorded program, that program may still be playing when the television is turned back on.

Conventionally, logging out of a set-top box requires the user to access one or more menus to locate and select a “logoff” option. The user cannot simply send a command to the set-top terminal to log out. Consequently, a user may frequently be inclined not to bother with such a procedure, but simply turn off the television, leaving the set-top box logged in.

Because the user did not logoff from the set-top box, the next person to turn on the television and find the set-top box logged in will have access to all the recordings of the previous, logged in user. The next person to turn on the television will be able to tune or access any of the channels or services available to the previous, still logged in user. Clearly, there are many scenarios in which it would be undesirable to have a subsequent user inadvertently gain access to the account and recordings of another user.

Consequently, the present specification provides various methods and systems by which a user can easily and rapidly log off from an account on a set-top box so as to prevent subsequent unauthorized access to that account.

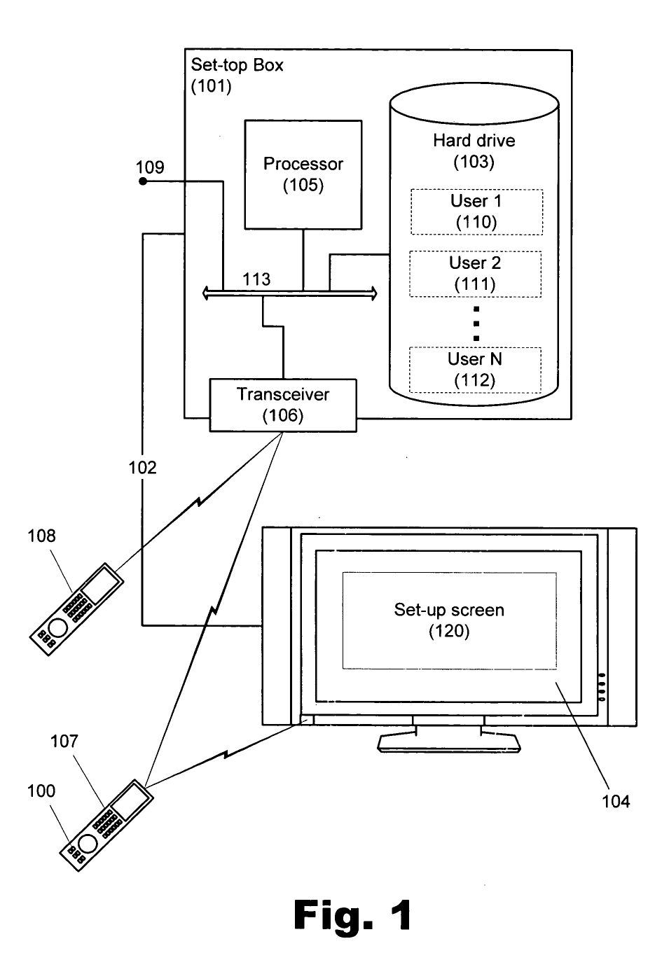

FIG. 1 is a diagram showing a set-top box and television set according to the principles described herein. As shown in FIG. 1, a set-top box (101) is connected to a television set (104) via a connection (102). This set-top box (101) may also have a connection (109) for receiving signals from a service provider. A processor (105) in the set-top box (101) processes the signals from the service provider and outputs programming signals that can be displayed by the television set (104). The set-top box (101) may also provide access to other services from the service provider such as pay-per-view programming, video-on-demand programming, etc.

Additionally, the illustrated set-top box (101) can record and playback video programming as desired by a user. The set-top box (101) includes a data storage device, in the illustrated example, a hard drive (103), on which programming can be recorded and from which recorded programming can be played back under control of the processor (105).

Both the set-top box (101) and the television set (104) may have an associated remote control unit for allowing a user to control the operation of that device. In the illustrated example, the television (104) is controlled by a first remote control unit (107), while the set-top box (101) is controlled by a second remote control unit (108).

The illustrated set-top box (101) includes a transceiver or receiver (106) for communicating with the corresponding remote control unit (108). The television (104) will also include a transceiver or receiver for communicating with the remote control unit (107) corresponding to the television set (104).

The transceiver (106) of the set-top box (101) may be, for example, an infra-red receiver for receiving an infra-red signal from the remote control unit (108). In other examples, the transceiver (106) may be a radio-frequency receiver or some other wireless transceiver for communicating with the remote control unit (108). A system bus (113) interconnects the various components in the set-top box (101).

As described above, the set-top box (101) may also allow various users to set-up separate accounts or user profiles that are accessed with a password or other identifier. Each user account may have restrictions placed thereon as to the channels, types of programming or services that user can access from the service provider or providers. These restrictions may be stored on the hard drive (103) as part of each separate user profile, for example, User 1 (110), User 2 (111) and User N (112).

Each user may also record programming of interest to that user. Programming recorded by one user, for example, User 1 will be stored on the hard drive (103) in associated with the profile of User 1 (110). The programming recorded by User 1 may only be accessible when User 1 is logged into the set-top box (101). Thus, the programming recorded by User 1 may be rendered inaccessible when another user, for example, User 2, is logged into the set-top box (101).

As noted above, however, when a user is done watching programming on the television (104), whether live broadcast or recorded, it is usually the case that the user simply turns off the television (104), but leaves the set-top box (101) on. The remote control unit (107) for the television set (104) includes a “power” or “on/off” button (100) that is pressed by the user to turn the television set (104) on or off. When the user is done watching programming, the typical user simply presses that power button (100) to turn off or deactivate the television set (104). The user typically does not bother to access the other remote control unit (108) or take other steps to turn off or log out of the set-top box (101).

In such a case, if the user is logged into a private account on the set-top box (101) and then turns off the television (104), leaving the set-top box (101) on, the user remains logged into the set-top box. As a result, the next user to turn on the television (104) will have access to the set-top box account of the previous user. Specifically, if the previous user had been watching a broadcast channel, that channel will likely still be tuned when the television is turned back on. If the previous user had been watching a playback of a recorded program, that program may still be playing when the television is turned back on.

As one means of addressing this scenario, the set-top box (101) illustrated in FIG. 1 can be programming to monitor for a signal from the remote control unit (107) for the television set (104) that deactivates the television set (104). When such a signal is received, the set-top box (101) then automatically logs off a user account that is active or “logged in” on the set-top box (101).

Using the remote control (106) for the set-top box (101), the user may place the set-top box (101) in a “capture mode” in which the set-top box (101) learns to recognize the signal from the other remote control unit (107) that turns off the television set (104). In the illustrated example, the set-top box (101) displays a set-up screen (120) on the television (104). The set-up screen instructs the user to press the power button (100) on the remote control (107) for the television (104).

When the power button (100) is pressed, the remote control (107) sends a signal to the television (104) to shut down or power off. This signal is also received by the transceiver (106) of the set-top box (101). The set-top box (101) records the signal in memory, e.g. on the hard drive (103), so that the set-top box (101) can subsequently recognize when a user has signaled the television (104) to shut down using the remote control unit (107). Anytime the remote control (107) is used to transmit a signal turning off the television (104), that same signal will also be received by the transceiver (106) of the set-top terminal (101). As will be described in further detail below, the set-top box (101) will automatically log out a user who is currently logged into the set-top box (101) when the signal is issued to turn off the television (104).

Thus, the signal turning off the television set also becomes a command to the set-top box to log out a user. The user need not access one or more menus on the set-top box to find a “log out” option to select.

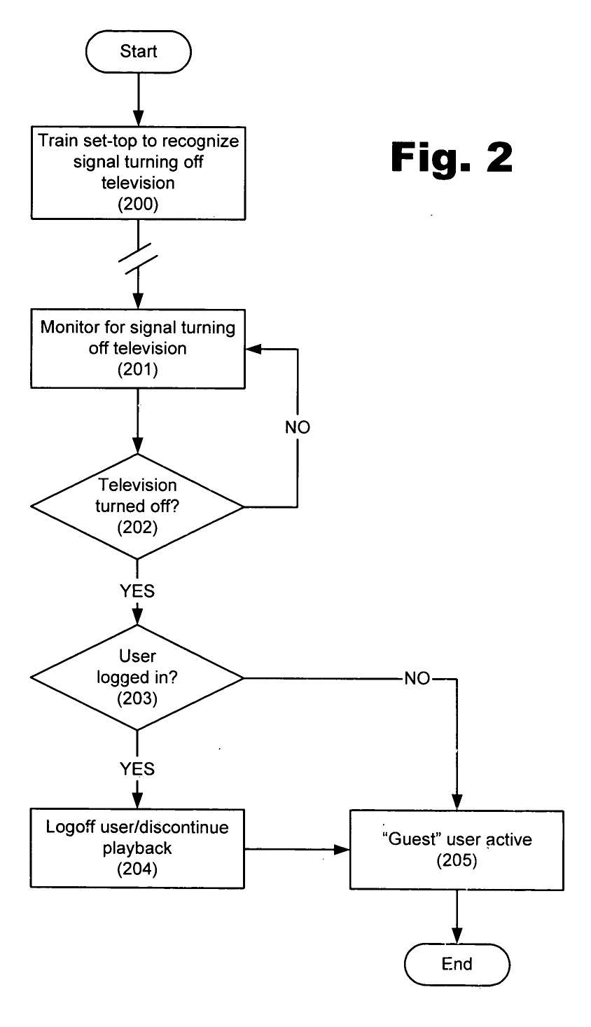

FIG. 2 is a flowchart showing a method of operating the set-top box and television set of FIG. 1. As shown in FIG. 2, the set-top box is first taught or trained to recognize the signal that deactivates the associated television set (step 200). This is done, for example, using the set-up screen and remote control unit for the television set as described above with reference to FIG. 1.

Alternatively, the set-top box may be pre-programmed by the manufacturer to recognize the signals used to turn off a variety of television sets, and the user need only indicate to the set-top box the identity of the television set actually being used so that the set-top terminal can then monitor for the corresponding signal that turns off that television set. The set-top box may display on the associated television a listing of the types of television sets for which the set-top box is pre-programmed to recognize a signal deactivating that television. The user then selects from the listing the television being used with the set-top box or to which the set-top box is connected.

After the set-top box is enabled to recognize when a remote control unit has signaled the associated television set to turn off, the set-top box will monitor for that signal (step 201). When the set-top box detects the signal that has been sent to cause the television set to deactivate (determination 202), the set-top box will determine if a user is then currently logged in (determination 203).

If a user is then currently logged in (determination 203), the set-top box will automatically logoff that user in response to receiving the signal telling the television set to deactivate (step 204). Additionally, if the set-top box is playing back recorded programming when the signal is received turning off the associated television, the set-top box may also discontinue playback of that recorded programming (step 204).

After the user has been automatically logged out, or if no user was then logged in, the set-top box enters a default mode, also known as being active for a “guest” user (step 205). In this mode, the set-top box will typically not allow access to the programming recorded by any of the designated users of the set-top box. Additionally, with regard to tuning incoming programming and services, the set-top box may operate under the most restrictive parameters applied for any of the user profiles programmed into the set-top box. However, the principal user may be able to define the access parameters for the “guest” user.

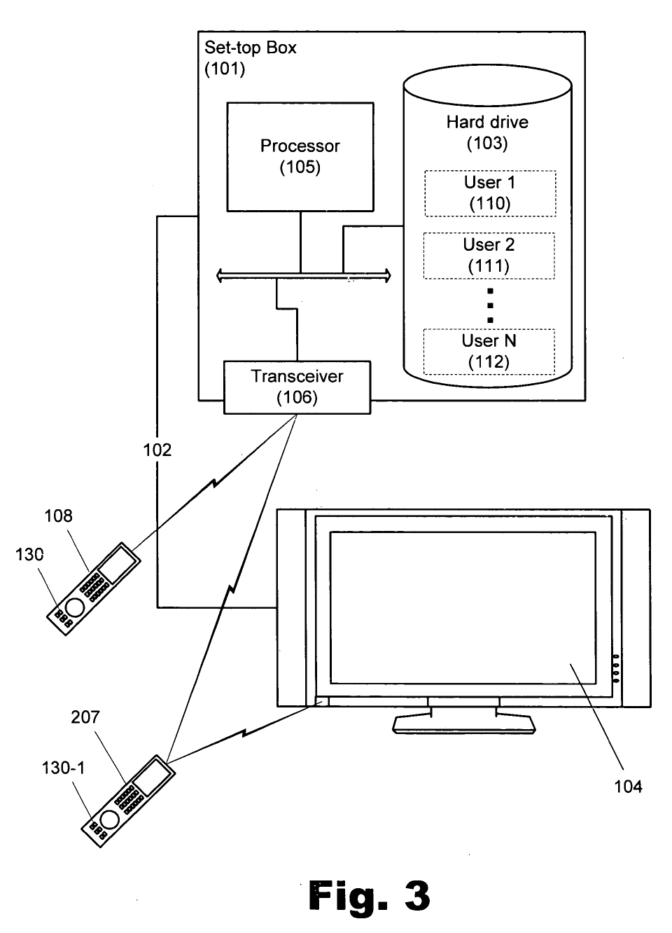

FIG. 3 is a diagram showing another set-top box and television set according to the principles described herein. As shown in FIG. 3, the set-top box (101) has its own remote control unit (108). This remote control unit (108) includes a dedicated button (130) that automatically causes the set-top box (101) to logoff a logged in user.

When the dedicated button (130) is pressed, the remote control unit (108) sends a signal to the set-top box (101) commanding the set-top box (101) to logout the currently logged in user. If more than one user is logged in, the signal can be interpreted as a command to logout all users, the most recently logged in user or the first logged in user.

Again, the dedicated button allows the logged in user to issue a log off command to the set-top box without having to access one or more menus looking for a logoff option to select. Thus, the dedicated button (130) provides a very easy means for a user to log out of the set-top box (101) when he or she is finished using the system. Consequently, the set-top box (101) is not likely to be left with a user still logged in such that another user may gain unauthorized or inappropriate access to the account of the logged in user. Additionally, the same dedicated button (130-1) can be incorporated into a remote control unit (207) that is used to control both the television set (104) and the set-top box (101).

Alternatively, the remote control unit (207) may be a universal remote control or a remote control that can record the signal from the other remote control (108) that signals the set-top box (101) to logoff a user. The signal can then be reproduced by the remote control (207) so as to signal the set-top box (101) to logoff a user. It is advantageous if one remote control unit is able to both signal the set-top box (101) to logoff a user and to also deactivate the television set (104).

The dedicated button (130, 130-1) can be a single button dedicated solely to the purpose of signaling the set-top box (101) to logoff a user. Alternatively, the dedicated button (130) can be a combination or sequence of buttons on the remote control unit that cause the remote control unit to signal the set-top box to logoff a user. For example, if the user presses the “fast forward” and “rewind” buttons simultaneously on the remote control unit, the remote control unit sends the signal commanding the set-top box to logoff a user. In another example, if the user presses a “shift” or “alt” button and then subsequently or simultaneously presses another button, that may cause the remote control unit to sends the signal commanding the set-top box to logoff a user. In still another example, the dedicated button (130, 130-1) may a soft button created on or in conjunction with a display device on the remote control unit (108, 207).

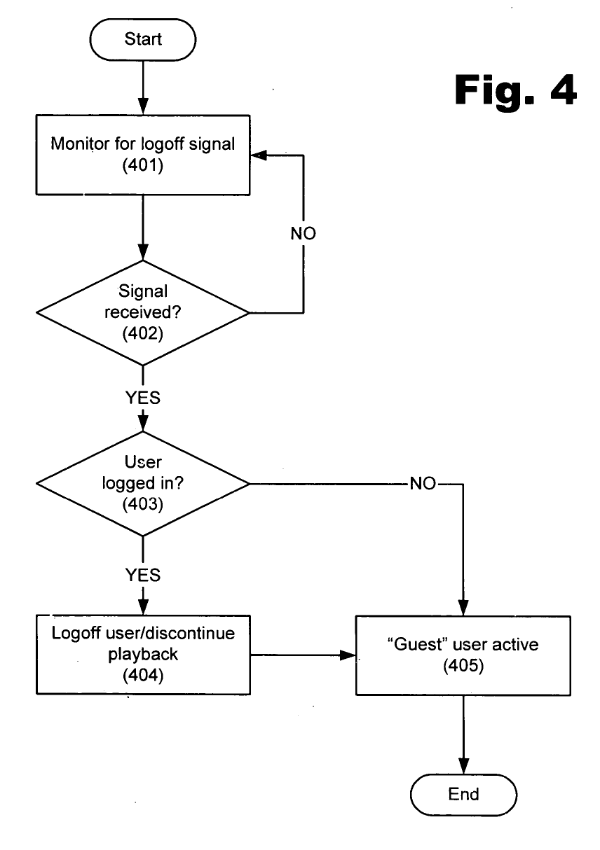

FIG. 4 is a flowchart showing a method of operating the set-top box and television set of FIG. 3. As shown in FIG. 4, the set-top box monitors for a signal from the remote control unit commanding the set-top box to logoff a user (step 401).

When the signal is received (determination 402), the set-top box checks to see if a user is currently logged in. (determination 403). If a user is logged in, the user is automatically logged out (step 404). If the logged in user was replaying recorded programming, the playback of that program is discontinued (step 404).

Once the user is logged out, or if no user was logged in, the set-top box is active for a “guest” user (step 405). As described above, in this mode, the set-top box will typically not allow access to the programming recorded by any of the designated users of the set-top box. Additionally, with regard to tuning incoming programming and services, the set-top box may operate under the most restrictive parameters applied for any of the user profiles programmed into the set-top box. However, the principal user may be able to define the access parameters for the “guest” user.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A set-top box comprising:
a processor; and
a receiver for communicating with a remote control unit,
wherein said processor is configured to receive a command from said remote control unit to automatically log a user off of said set-top box.

2. The set-top box of claim 1, wherein said set-top box further comprises a memory for storing parameters for a number of individual user profiles.

3. The set-top box of claim 2, wherein said memory comprises a hard drive.

4. The set-top box of claim 2, wherein said memory contains television programs recorded in association with a particular user profile.

5. The set-top box of claim 1, wherein said command from said remote control unit is generated by pressing a dedicated button on said remote control unit.

6. The set-top box of claim 1, wherein said command from said remote control unit is generated by pressing a sequence of buttons on said remote control unit.

7. The set-top box of claim 1, wherein said command from said remote control unit is generated by simultaneously pressing two or more buttons on said remote control unit.

8. The set-top box of claim 7, wherein said command from said remote control unit is generated by simultaneously pressing a “fast forward” button and a “rewind” button on said remote control unit.

9. The set-top box of claim 1, wherein said command from said remote control unit is also a command to deactivate a television set associated with said set-top box.

10. The set-top box of claim 9, wherein said processor is configured to record a signal from a remote control unit of said television set commanding said television set to deactivate, said processor then recognizing said signal as said command to automatically logoff said user from said set-top box.

11. The set-top box of claim 10, further wherein said processor is configured to display a set-up screen on said television set when said set-top box is prepared to record said signal.

12. The set-top box of claim 1, wherein said processor activates a guest user profile when said user is logged off.

13. The set-top box of claim 1, wherein said processor discontinues playback of recorded programming in conjunction with automatically logging off said user.

14. A method of operating a set-top box comprising:
receiving a command from a remote control unit to automatically log a user off of said set-top box; and
in response to said command, automatically logging a user off of said set-top box.

15. The method of claim 14, further comprising storing parameters for a number of individual user profiles on a memory of said set-top box.

16. The method of claim 15, further comprising recording television programs that are stored in association with a particular user profile.

17. The method of claim 14, further comprising generating said command from said remote control unit by pressing a dedicated button on said remote control unit.

18. The method of claim 14, further comprising generating said command from said remote control unit by pressing a sequence of buttons on said remote control unit.

19. The method of claim 14, further comprising generating said command from said remote control unit by simultaneously pressing two or more buttons on said remote control unit.

20. The method of claim 19, further comprising generating said command from said remote control unit by simultaneously pressing a “fast forward” button and a “rewind” button on said remote control unit.

21. The method of claim 14, wherein said command from said remote control unit is also a command to deactivate a television set associated with said set-top box.

22. The method of claim 21, further comprising:
recording a signal from a remote control unit of said television set commanding said television set to deactivate; and
then recognizing said signal as said command to automatically logoff said user from said set-top box.

23. The method of claim 22, further comprising displaying a set-up screen on said television set when said set-top box is prepared to record said signal.

24. The method of claim 14, further comprising activating a guest user profile when said user is logged off.

25. The method of claim 14, further comprising discontinuing playback of recorded programming in conjunction with automatically logging off said user.

26. A set-top box comprising:
means for receiving a command from a remote control unit to automatically log a user off of said set-top box; and
means for automatically logging said user off of said set-top box in response to said command.

27. The set-top box of claim 26, further comprising means for storing parameters for a number of individual user profiles in said set-top box.

28. The set-top box of claim 27, further comprising means for recording television programs that are stored in association with a particular user profile.

29. The set-top box of claim 26, further comprising means for generating said command from said remote control unit including a dedicated button on said remote control unit.

30. The set-top box of claim 26, further comprising means for generating said command from said remote control unit including a sequence of buttons on said remote control unit.

31. The set-top box of claim 26, further comprising means for generating said command from said remote control unit including two or more buttons on said remote control unit that are pressed simultaneously to generate said command.

32. The set-top box of claim 31, wherein said means for generating said command from said remote control unit include a “fast forward” button and a “rewind” button that are simultaneously pressed on said remote control unit to generate said command.

33. The set-top box of claim 26, wherein said command from said remote control unit is also a command to deactivate a television set associated with said set-top box.

34. The set-top box of claim 33, further comprising:
means for recording a signal from a remote control unit of said television set commanding said television set to deactivate; and
means for recognizing said signal as said command to automatically logoff said user from said set-top box.

35. The set-top box of claim 34, further comprising means for displaying a set-up screen on said television set when said set-top box is prepared to record said signal.

36. The set-top box of claim 22, further comprising activating a guest user profile when said user is logged off.

37. The set-top box of claim 22, further comprising means for discontinuing playback of recorded programming in conjunction with automatically logging off said user.

38. A video system comprising:
a set-top box;
a television; and
a remote control unit for controlling said television,
wherein said set-top box is configured to recognize a command from said remote control unit to deactivate said television and said set-top box automatically logs a user off of said set-top box in response to receiving said command to deactivate said television.

39. The system of claim 38, wherein said set-top box further comprises a memory for storing parameters for a number of individual user profiles.

40. The system of claim 39, wherein said memory contains television programs recorded in association with a particular user profile.

41. The system of claim 38, wherein said set-top box is configured to record a signal from said remote control unit commanding said television to deactivate, said set-top box then recognizing said signal as said command to automatically logoff said user from said set-top box.

42. The system of claim 41, further wherein said set-top box is configured to display a set-up screen on said television when said set-top box is prepared to record said signal.

43. The system of claim 38, wherein said set-top box activates a guest user profile when said user is logged off.

44. The system of claim 38, wherein said set-top box discontinues playback of recorded programming in conjunction with automatically logging off said user.

45. A set-top box system comprising:
a processor;
a remote control unit; and
a receiver for communicating with said remote control unit,
wherein said processor is configured to receive a specific command from said remote control unit to automatically log a user off of said set-top box.

46. The system of claim 45, wherein said set-top box further comprises a memory for storing parameters for a number of individual user profiles.

47. The system of claim 46, wherein said memory contains television programs recorded in association with a particular user profile.

48. The system of claim 45, wherein said command from said remote control unit is generated by pressing a dedicated button on said remote control unit.

49. The system of claim 45, wherein said command from said remote control unit is generated by pressing a sequence of buttons on said remote control unit.

50. The system of claim 45, wherein said command from said remote control unit is generated by simultaneously pressing two or more buttons on said remote control unit.

51. The system of claim 50, wherein said command from said remote control unit is generated by simultaneously pressing a “fast forward” button and a “rewind” button on said remote control unit.

52. The system of claim 45, wherein said processor activates a guest user profile when said user is logged off.

53. The system of claim 45, wherein said processor discontinues playback of recorded programming in conjunction with automatically logging off said user.
